(19) United States
(12) Patent Application Publication
(10) Pub. No.: US 2024/0051711 A1
(43) Pub. Date: Feb. 15, 2024

(54) PARTS BOX

(71) Applicant: Wang-Ta Shieh, Kaohsiung City (TW)

(72) Inventor: Wang-Ta Shieh, Kaohsiung City (TW)

(21) Appl. No.: 17/942,192

(22) Filed: Sep. 12, 2022

(30) Foreign Application Priority Data
Aug. 10, 2022 (TW) 111208650

(51) Int. Cl. B65D 25/22; B25H 3/02

(52) U.S. Cl. CPC B65D 25/22; B25H 3/02

(57) ABSTRACT

A parts box includes a box body and cover, where the box body has an hand tool parts accommodating space, and a rear side wall of the box body is provided with a positioning convex portion; the cover covers the box body, and is provided with an opening, an end side of the cover opposite to the opening is connected with a liftable closing element for closing or exposing the opening; a bottom end of a rear side of the cover is connected with a liftable hanging sheet provided with a hanging hole and at least one positioning hole, and the positioning hole corresponds to the positioning convex portion provided on the box body; a rear side of the cover is provided with a groove for the engagement of the hanging sheet with it, allowing the hanging hole to be positioned more highly than a top surface of the cover.

### (a) TECHNICAL FIELD OF THE INVENTION

The present invention relates to a parts box, and more particularly to a parts box structure, having a hanging card that can be hung, bent and positioned.

### (b) DESCRIPTION OF THE PRIOR ART

The parts box 10 currently available in the market for accommodating hand tool parts (such as: driver bits, screws, nails, etc.), as shown in FIG. 1, mainly includes a box body 11 provided with a cover 12, where an opening 121 is opened on the cover 12, and the opening 121 is provided with a closable closing element 122. With the above structure, the hand tools in the box body 11 can be taken out to use after the closing element 122 is opened.

The above conventional parts box 10 must be additionally packed in a paper board or plastic board 20 for hanging upon display for sale. However, the hanging paper board or plastic board 20 not only increases the production cost but cannot be used any more after detached and thus destroyed, causing the parts boxes 10 to be stacked only and unable to be hung upon storage, which is inconvenient in use.

To overcome the above disadvantage, it is designed to set an opening on the rear side of the box body 11, and the opening is inserted with a lock pin on which a rotatable hanging rotating sheet is configured. Although the hanging rotating sheet of the parts box 10 is reusable, the production cost is increased due to the large number of parts and cumbersome assembly, and the storage space will be compressed because the entire volume is larger. Therefore, there are still inconvenient shortcomings to be overcome.

### SUMMARY OF THE INVENTION

To overcome the above disadvantages, the present invention is proposed. One object of the present invention is to provide a parts box structure, having a hanging card capable of being hung for use and being bent, positioned for fixing.

To achieve the above object, the present invention proposes a parts box, including a box body and cover, where the box body has an accommodating space adapted to accommodate a plurality of hand tool parts, and a rear side wall of the box body is at least provided with a positioning convex portion; the cover is firmly assembled on and covers the box body, and adapted to close the box body, the cover is provided with an opening, an end side of the cover opposite to the opening is connected with a liftable closing element, and the closing element is matched with the opening and used for closing or exposing the opening; a bottom end of a rear side of the cover is connected with a liftable hanging sheet provided with a hanging hole and at least one positioning hole, and the positioning hole corresponds to the positioning convex portion provided on the box body; a rear side of the cover is provided with a groove, allowing the hanging sheet to be lifted up to engage with the groove, and allowing the hanging hole provided on the hanging sheet to be positioned more highly than a top surface of the cover.

With the above structure, the parts box structure of the present invention has the hanging card capable of being hung for use, and being bent, positioned for fixing.

### BRIEF DESCRIPTION OF THE DRAWINGS

FIG. 1 is an exploded view of a conventional parts box;

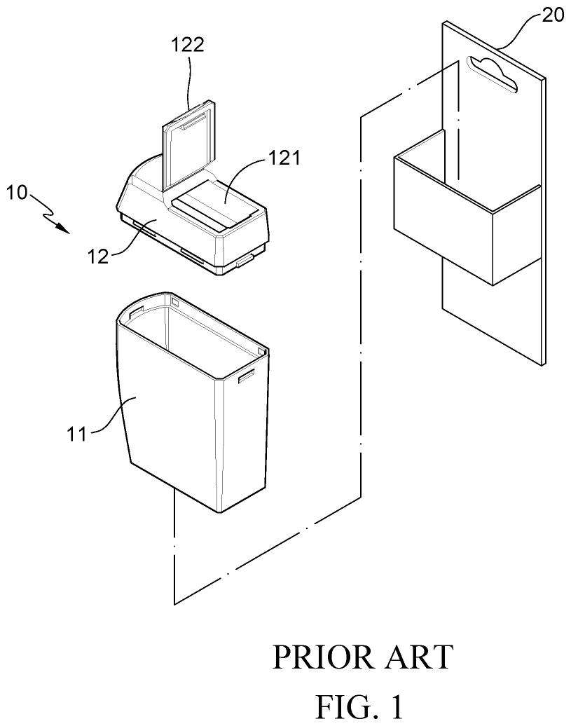

FIG. 2 is an exploded view of the present invention;

FIG. 3 is a perspective view of the present invention;

FIG. 4 is a perspective view of the present invention, where a hanging sheet is in engagement with a groove;

FIG. 5 is a cross-sectional view of the present invention, where the hanging sheet is in engagement with the groove;

FIG. 6 is a perspective view of the present invention, where the hanging sheet is positioned on the rear side surface of a box body; and

FIG. 7 is a cross-sectional view of the present invention, where the hanging sheet is positioned on the rear side surface of a box body

### DETAILED DESCRIPTION OF THE PREFERRED EMBODIMENTS

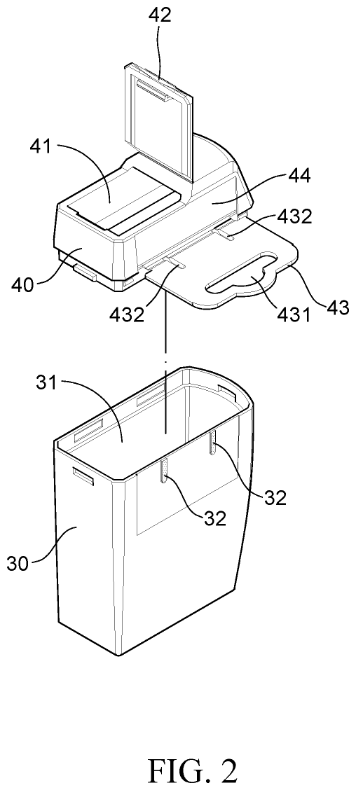

About the technical means and structure used in the present invention to achieve the object, hereby I would like to cooperate with the embodiments shown in FIGS. 2 to 7, and the detailed description is as follows Referring to FIG. 2, a parts box of the present invention, in a preferred embodiment, includes a box body 30 and a cover 40.

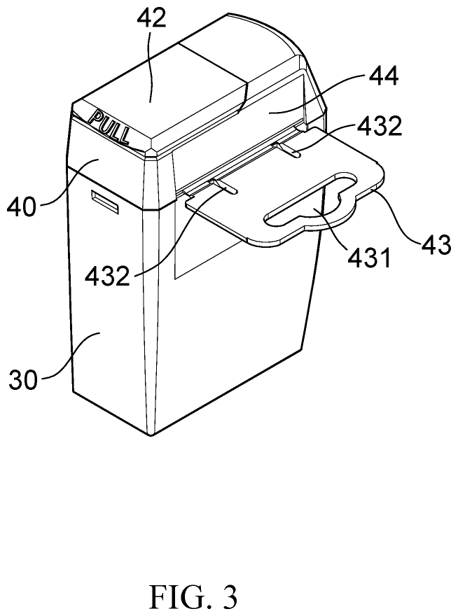

Referring to FIG. 3, the box body 30 has an accommodating space 31 adapted to accommodate a plurality of hand tool parts, and the rear side wall of the box body 30 is at least provided with a convex portion 32.

The cover 40 provided with an opening 41 (also referring to FIG. 3) is firmly assembled on and covers the box body 30 and adapted to cover close the box body 30, a end side of the cover 40 opposite to the opening 41 is connected with a liftable closing element 42 matching with the opening to close or expose the opening 41; the bottom end of the rear side of the cover 40 is connected with a hanging sheet 43 capable of being turned up and down, where the hanging sheet 43 is provided with a hanging hole 431 and at least one positioning hole 432, and the positioning hole 432 corresponds to and matches with the convex portion 32 provided on the box body 30. Furthermore, the rear side of the cover 40 is provided with a groove 44, allowing the lower side of the hanging sheet 43 to be engaged with and positioned in it after the hanging sheet 43 is lifted up, and allowing the hanging hole 431 provided on the hanging sheet 43 positioned more highly than the top surface of the cover 40.

Following the above, the two sides of the hanging sheet 43 each, in a preferred embodiment, is wedge-shaped, so as to improve the engagement tightness between the hanging sheet 43 and the groove 32.

Following the above, the convex portion 32 configured on the box body and the positioning hole 42 opened on the hanging sheet 43 corresponding to each other may respectively be elongated, circular, oval, or other geometric shapes.

Following the above, in a preferred embodiment, the convex portion portions 32 of the box body 30 number two, and the positioning holes 432 of the hanging sheet 43 also two, which is the best.

Following the above, in a preferred embodiment, the two convex portions 32 provided on the box body 30 and the two positioning holes 432 opened on the hanging piece 43 are optimally distributed evenly, respectively.

With the above structure, the cover 40 is assembled on the box body 30 after the box body 30 is accommodated with a plurality of hand tool parts (such as driver bits, screws, nails, etc.), and the hand tool parts can then be conveniently carried. Upon use, the closing element 42 can be lifted up to open to expose the opening 41, and the hand tool parts in the box body 30 can then be taken out to use. Thereafter, the closing element 42 is turned down to cover the opening 41 again, thereby preventing the hand tool parts from falling out.

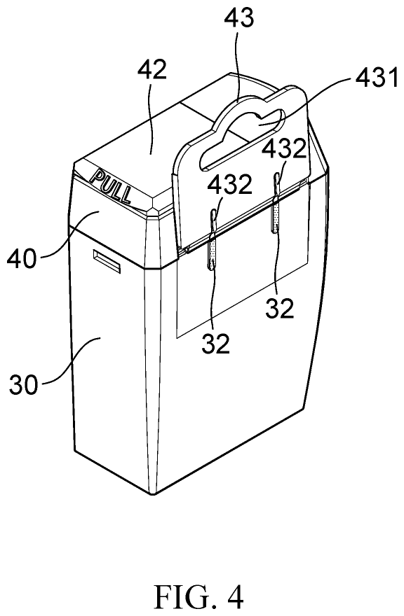

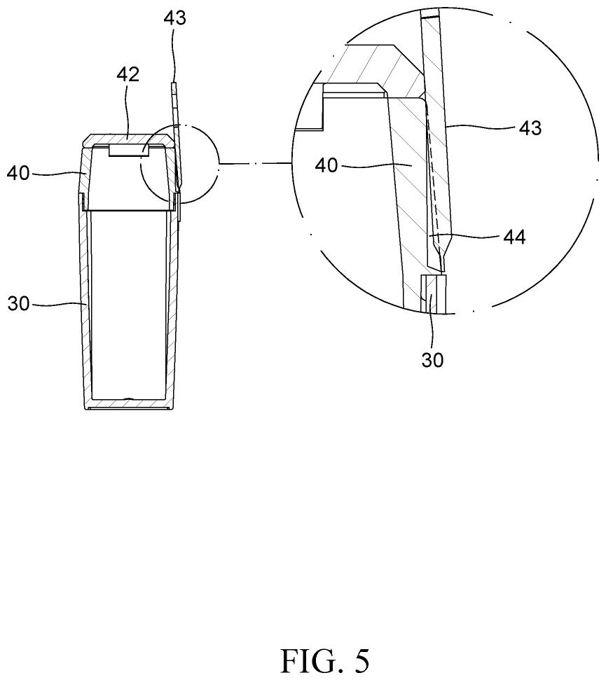

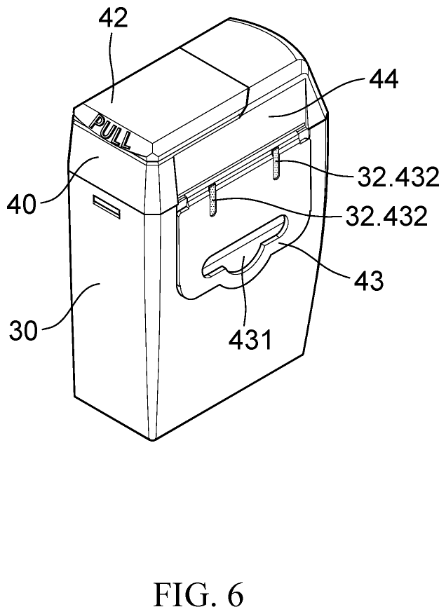

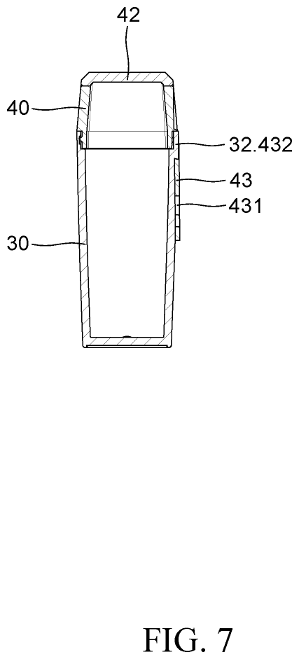

When the parts box of the present invention wants to be used, the hanging sheet 43 is lifted up, and the lower side of the hanging sheet 43 is then caused to be engaged with the groove 44 configured on the cover 40 as shown in FIG. 4, and the hanging sheet 43 can then be positioned and fixed on the rear side of the cover body 40 upright as shown in FIG. 5. Whereby, personnel can then use the hanging hole 431 to hang and display the parts box. When the parts box wants to be carried, taken, arranged or stacked without hanging it, the personnel can turn the hanging sheet 43 down, so that the hanging box 43 can be released from the engagement with the groove 44. Thereafter, the hanging sheet 43 is turned downward to attach the box body as shown in FIG. 6, allowing the positioning hole 432 provided on the hanging sheet 43 to be engaged with the convex portion 32 configured on the box body 30 to position and fix the hanging sheet 43 on the rear side surface of the box body 30, and the hanging sheet 43 will not be protruded out of the top surface of the box body 40 as shown in FIG. 7. At this time, since the hanging sheet 43 is closely attached to the rear side of the box body 30, the entire volume and occupied space will not be substantially increased, so that the parts box can be easily carried and stacked.

from the above description, it can be known that the present invention has the following advantages compared to the prior arts:
1. since the hanging sheet 43 is connected to the cover body 40, the present invention is made in one piece, so that the present invention does not need to additionally pack the hanging paper board (or plastic board), and can be hung repeatedly, which can actually reduce production costs and improve practicability;
2. since the cover 40 is provided with a groove 44 allowing the hanging sheet 43 to be engaged therewith, the hanging sheet 43 is formed in an upright shape and can be used without the need to arrange other elements for positioning, so that the present invention is structurally simple, and actually has the advantage of operational simplicity and quickness; and
3. since the box body 30 is integrally formed with the positioning convex portions 32 that can be engaged with the positioning holes 432 provided on the hanging sheet 43 and the hanging sheet can then be positioned and fixed after turned down, so that the hanging sheet will not rise and protrude, and since the hanging sheet 43 is closely attached to the rear side surface of the box body 30, the entire volume and occupied space will not substantially be increased, which actually can improve stacking neatness and carrying convenience.

I claim:

1. A parts box, comprising a box body and cover, wherein:
said box body has an accommodating space adapted to accommodate a plurality of hand tool parts, and a rear side wall of said box body is at least provided with a positioning convex portion;
said cover is firmly assembled on and covers said box body, and adapted to close said box body, said cover is provided with an opening, an end side of said cover opposite to said opening is connected with a liftable closing element, and said closing element is matched with said opening and used for closing or exposing said opening; a bottom end of a rear side of said cover is connected with a liftable hanging sheet provided with a hanging hole and at least one positioning hole, and said positioning hole corresponds to said positioning convex portion provided on said box body; a rear side of said cover is provided with a groove, allowing said hanging sheet to be lifted up to engage with said groove, and allowing said hanging hole provided on said hanging sheet to be positioned more highly than a top surface of said cover.

2. The parts box according to claim 1, wherein two sides of said hanging sheet each is wedge-shaped.

3. The parts box according to claim 1, wherein said positioning convex portion provided on said box body and said positioning hole corresponding thereto provided on said hanging sheet respectively are elongated, circular, oval or other geometric shapes.

4. The parts box according to claim 1, wherein said cover is optionally provided with two positioning convex portions, and said hanging sheet two positioning holes.

5. The parts box according to claim 4, wherein said positioning convex portions provided on said box body and said positioning holes proved on said hanging sheet are optionally evenly distributed, respectively.
